(19) United States
(12) Patent Application Publication
(10) Pub. No.: US 2022/0213292 A1
(43) Pub. Date: Jul. 7, 2022

(54) CURABLE CASTING COMPOUND FOR THE MANUFACTURE OF MOLDED PLASTICS

(71) Applicant: BLANCO GMBH + CO KG, Oberderdingen (DE)

(72) Inventor: Andreas HAJEK, Weingarten (DE)

(73) Assignee: BLANCO GMBH + CO KG, Oberderdingen (DE)

(21) Appl. No.: 17/568,318

(22) Filed: Jan. 4, 2022

(30) Foreign Application Priority Data
Jan. 7, 2021 (DE) 10 2021 200 091.6

(51) Int. Cl. C08K 3/22; B29C 39/00

(52) U.S. Cl. CPC C08K 3/22; B29C 39/006; B29K 2033/04; C08K 2201/01; C08K 2201/003; C08K 2003/2275

(57) ABSTRACT

The invention relates to a curable casting compound for the manufacture of molded plastics, comprising a binder component composition and a composition of the filler component, wherein the filler component composition comprise at least one magnetic metal oxide, in particular magnetite, in a proportion of 1 to 100 percent by weight, in relation to the total mass of the composition of the filler component.

The invention relates to a curable casting compound for the manufacture of molded plastics comprising a binder component composition and a composition of the filler component.

The invention further relates to a use of a curable casting compound.

The invention further relates to a molded plastic made using a curable casting compound.

The invention further relates to a securing system comprising a molded plastic.

Curable casting compounds are used for the manufacture of molded plastics, especially in the sanitary or kitchen sector, such as kitchen sinks, countertops, bathtubs, washbasins or the like. The curable casting compounds usually comprise a binder material and a filler material to improve the mechanical properties of the molded plastics, as has become known, for instance, from DE 38 32 351 A1, WO 93/10159 A1 or WO 2005/071000 A1.

From EP 0 096 522 A2 a curable casting compound and a molded plastic is known. The curable casting compound has a proportion of metal powder comprising, for instance, elemental iron, to impart magnetic properties to the molded plastic. This has the disadvantage of rendering the processing of the casting compound costly and difficult because of the metal powder.

WO 2008/129055 A1 discloses a system having a sink and a rinsing brush that can be detachably attached to the sink by means of magnetic force. For this purpose, a magnet is arranged in or on the sink wall, which interacts with a corresponding magnet in the sink brush and in that way secures the sink brush to the sink. The disadvantage here is again that the position of the magnet is determined in advance. Another disadvantage—costly manufacture—occurs in particular when the magnet has to be placed in the sink wall. For this purpose, it has to be held in a suitable position during the manufacture of the sink.

This invention therefore addresses the problem of providing a curable casting compound and molded plastics made therefrom, providing a simpler and less expensive manufacture and at the same time more flexible options of specification with regard to the position of additional components.

This invention further addresses the problem of providing an alternative curable casting compound and molded plastics made therefrom.

This invention solves the above problems for a curable casting compound for the manufacture of molded plastics, comprising a binder component composition and a composition of the filler component, in that the composition of the filler component comprises at least one magnetic metal oxide, in particular magnetite, in a proportion from 1 to 100 percent by weight, in relation to the total mass of the composition of the filler component.

This invention also solves the problems mentioned above by using a curable casting compound according to any one of claims 1 to 8 for the manufacture of a molded plastic for the kitchen and/or sanitary sector, in particular kitchen sinks and countertops for kitchens.

This invention also solves the problems by means of a molded plastic manufactured using the curable casting compound according to any one of claims 1 to 8, in particular by means of a casting process.

This invention also solves the problems by a securing system comprising a molded plastic according to claim 10 and at least one magnetic or magnetizable accessory element for securing to the molded plastic by means of magnetic force.

In particular, a weight proportion of 5%, 10% and/or 15% of magnetite is explicitly excluded.

One of the advantages achieved in that way is, for one, facilitating the processability of the curable casting compound: By using magnetic metal oxides, in particular ferrimagnetic magnetite instead of pure ferromagnetic metal particles, the overall magnetic forces are smaller, which facilitates easy deagglomeration of the magnetite in the curable casting compound. In addition, when very low final concentrations of magnetic metal oxides, in particular magnetite, were used, it surprisingly turned out that sufficient magnetic forces were present to detachably secure accessory elements to the molded plastics manufactured using the curable casting compound. If granular mineral particles are added to the curable casting compound, it is further ensured that the compound can be used to obtain molded plastics having a textured surface, for instance a decorative granite surface.

The term “magnetite” is defined in the broadest sense and, in particular in the description, preferably in the claims, refers not only to pure crystals of Fe(II, III) oxide but also to solid solutions containing only a proportion of Fe(II, III) oxide, in particular titaniferous magnetite. The term “magnetite” also includes maghemite, γ-Fe₂O₃.

Further features, advantages and further embodiments of the invention are described below or became apparent.

According to a preferred embodiment, the at least one magnetic metal oxide has a proportion of at least 50 percent by weight in relation to the total mass of the composition of the filler component. One of the resulting advantages is the provision of a high magnetic force without significantly complicating the processability of the curable casting compound.

According to a further preferred embodiment, the at least one magnetic metal oxide has a proportion of 15 to 50 percent by weight, preferably 20 to 40 percent by weight, in particular 25 to 30 percent by weight, in relation to the total mass of the composition of the filler component. One of the advantages that can be achieved in this way is the provision of sufficient magnetic force while at the same time making the curable casting compound easy to process.

According to a further preferred embodiment, the at least one magnetic metal oxide is provided in the form of granular magnetite. The advantage thereof is the magnetite being easy to process further.

According to a further preferred embodiment, the granular magnetite has an average diameter of 100 to 500 microns, preferably 200 to 400 microns, more preferably 250 to 350 microns. One of the advantages thereof is the good homogenization of the magnetite in the curable casting compound.

According to a further preferred embodiment, the binder component composition comprises at least a portion of a liquid monomeric acrylate. The advantage thereof is that it can be polymerized to a polyacrylate during the manufacture of a molded plastic while curing. To increase the viscosity of the curable casting compound, a proportion of a pre-polymerized acrylate component can be added to the monomeric acrylate, for instance, pre-polymerized polymethyl methacrylate PMMA can be added to the monomeric methyl methacrylate.

According to a further preferred embodiment, the composition of the filler component comprises a proportion of a peroxide mixture. Its advantage is its simple controllability of the polymerization during the manufacture of the molded plastic.

According to further preferred embodiment, the curable casting compound has a colorant material composition of 0.1 percent by weight to 20 percent by weight, in particular of 0.5 percent by weight to 10 percent by weight, in particular of 1 percent by weight to 5 percent by weight. The advantage thereof is that the color impression of the molded plastic manufactured can be adapted in a simple manner by means of the curable casting compound, in particular the black color impression of magnetite can be covered or at least weakened if no black color impression of the molded plastic is to be provided.

According to a further preferred embodiment of the securing system, the accessory element comprises at least one magnetic element, which is connected to the accessory element, in particular by means of an adhesive connection. One of the possible advantages thereof is the simple, cost-effective and rapid provision of magnetic accessories, even if they do not have magnetic properties per se.

Further important features and advantages of the invention are described in more detail in the dependent claims and in the explanation below.

It goes without saying that the features mentioned above and those to be explained below can be used not only in the combination indicated in each case, but also in other combinations or on their own, without departing from the scope of this invention.

Preferred designs and embodiments of the invention are explained in more detail and with reference to the drawings in the description below.

In the Figures

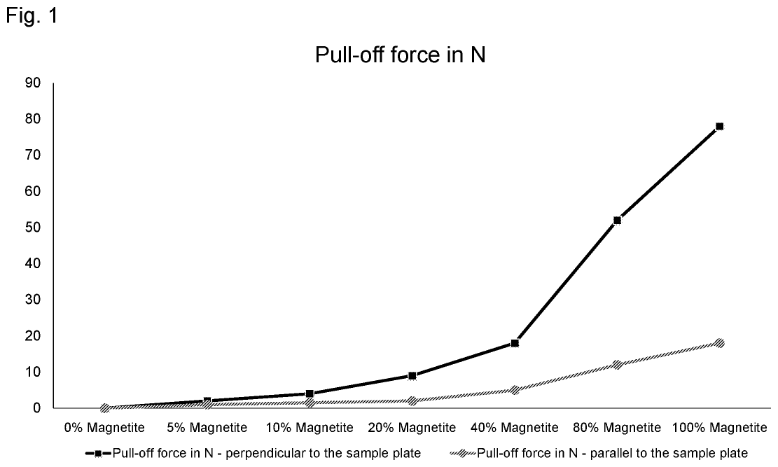

FIG. 1 shows the pull-off force perpendicular and in parallel to a sample plate of a molded plastic according to one embodiment of this invention; and

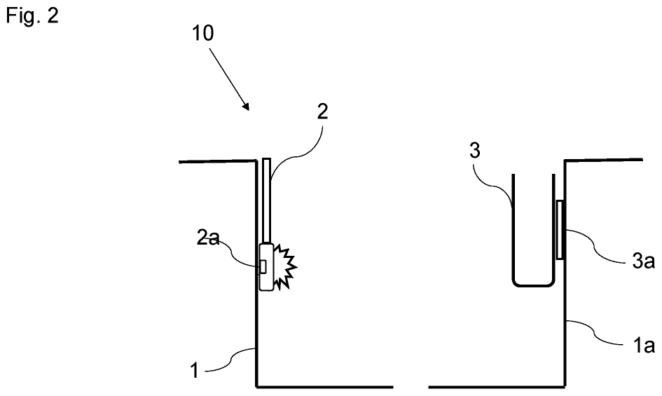

FIG. 2 shows a schematic representation of a securing system according to one embodiment of this invention.

It became evident that when metal oxides with magnetic properties are used in accordance with the invention, even at low final concentrations in the range of 1.0 percent by weight, in particular more than 3.0 percent by weight, preferably more than 5.0 percent by weight in the curable casting compound, a considerable magnetic force can be provided in conjunction with commercially available magnets.

### COMPARATIVE EXAMPLE

A curable casting compound is prepared by adding a filler material to a binder material according to EP 1 487 906 A1, which is hereby incorporated by explicit reference. The binder material is essentially obtained by dissolving PMMA in MMA, wherein a demolding agent and crosslinking monomers are added. A binder syrup is obtained in that way.

The filler material comprises granular quartz material Granucol® (Gebrüder Dorfner GmbH & Co., Hirschau) and magnetite (LKAB Minerals GmbH). The types of Granucol® and magnetite listed below were used:
Granucol® white 2/9 (mean grain size 330 microns)
Magnetite (mean diameter 300 microns)

If, in particular, different Granucol® grades are used, which can be colored differently, a particularly attractive granite decor appearance can be achieved.

The filler material is now added to the binder material and homogeneously mixed therewith. Furthermore, a color material mixture is added to the curable casting compound to adjust the desired color of the later molded plastic.

The casting compound is then thermally cured by means of free-radical polymerization.

In addition, the binder may also comprise one or more cross-linking agents. Cross-linking agents are, for instance, substances from the group of aliphatic or aromatic di-, tri- or multifunctional acylates or methacrylates and/or epoxy acrylates or methacrylates and/or aliphatic or aromatic di-, tri- or multifunctional urethane acrylates or methacrylates and/or di-, tri- or multifunctional polyester acylates or methacrylates and/or di-, tri- or multifunctional silicone acrylates or methacrylates, silicone urethane acrylates or methacrylates and silicone polyester acrylates or methacrylates, or combinations thereof.

The composition of the curable casting compound according to a comparative example is again shown in general form in Table 1 below, wherein the contents of the individual components are specified in percent by weight.

TABLE 1
Composition of the comparative example:

| Component | Percent by weight |
|---|---|
| Binder* (PMMA in MMA) | 23.07 |
| *(PMMA: approx. 19 percent by weight, | |
| MMA: approx. 81 percent by weight) | |
| Trimethylolpropane trimethacrylate | 1.89 |
| Peroxide mixture | 0.60 |
| Heucodur ® HD952 | 1.66 |
| Iriodin ® 163 | 0.18 |
| Granucol ® white 2/9 | 72.60 |
| Total | 100.00 |

As mentioned above, the curable casting compound is then placed in a casting mold for a kitchen sink and polymerized by being exposed to heat.

A sample plate is cut out of the kitchen sink and a predetermined pull-off element comprising a permanent magnet having a magnetic flux density of about 350 mT, which is provided with a hook, is used to measure the pull-off force both perpendicular to the sample plate and in parallel to the sample plate. A manual force gauge model I-FGA 08 by Induk GmbH was used to measure the pull-off force.

The molded plastic manufactured in this way according to the comparative example does not contain any magnetite (FIG. 1, Magnetite: 0 percent by weight). It was impossible to determine any magnetic properties, i.e., the respective pull-off forces are 0 N according to FIG. 1.

### Examples 1 to 6

A casting compound according to the invention is manufactured, the composition of which largely matches the curable casting compound of the comparative example, wherein essentially a quantity of magnetite (company LKAB Minerals GmbH) is added as a replacement of a matching quantity of Granucol® and, in the case of higher contents of magnetite, additionally also as a replacement of quantities of further components.

The composition of the curable casting compound for Examples 1 to 6 is shown in Table 2 below, wherein the contents of the individual components are specified in percent by weight, in each case in relation to 100 kg of curable casting compound.

TABLE 2
Composition of the casting compound modified using magnetite:

| | Content of magnetite filler in percent by weight | | | | | |
|---|---|---|---|---|---|---|
| | 5 | 10 | 20 | 40 | 80 | 100 |
| Component | Ex. 1 | Ex. 2 | Ex. 3 | Ex. 4 | Ex. 5 | Ex. 6 |
| Binder* | 23.64 | 22.20 | 21.18 | 18.40 | 17.40 | 13.27 |
| (PMMA in MMA) | | | | | | |
| *(PMMA: approx. 19 percent by | | | | | | |
| weight, MMA: approx. 81 percent | | | | | | |
| by weight) | | | | | | |
| Trimethylolpropane | 1.91 | 1.92 | 1.91 | 1.89 | 1.89 | 1.24 |
| trimethacrylate | | | | | | |
| Peroxide mixture | 0.60 | 0.56 | 0.56 | 0.49 | 0.47 | 0.35 |
| Heucodur ® HD952 | 1.66 | 1.69 | 1.72 | 1.78 | 1.80 | 1.13 |
| Iriodin ® 163 | 0.18 | 0.19 | 0.19 | 0.20 | 0.20 | 0.13 |
| Granucol ® white 2/9 | 68.37 | 66.00 | 59.44 | 46.14 | 15.34 | 0.00 |
| Magnetite (d50, approx. 300 μm) | 3.64 | 7.44 | 15.00 | 31.10 | 62.90 | 83.88 |
| Total | 100.00 | 100.00 | 100.00 | 100.00 | 100.00 | 100.00 |

As described for the curable casting compound according to the comparative example, the curable casting compound according to Examples 1 to 6 is used to produce one kitchen sink each.

A sample plate is again cut out of the kitchen sink and a predetermined pull-off element comprising a permanent magnet having a magnetic flux density of about 350 mT, which is provided with a hook, is used to measure the pull-off force both perpendicular to the sample plate and in parallel to the sample plate. A manual force gauge model I-FGA 08 by Induk GmbH was used to measure the pull-off force.

In the molded plastics manufactured in that way according to Examples 1 to 6, the magnetite content was increased with every increment of the numbering of the examples. The respective pull-off forces are shown in FIG. 1 and show an increase of the respective pull-off forces with increasing magnetite content, in particular these show a substantially linear increase of the pull-off forces perpendicular to the sample plate with respect to a matching increase of the magnetite content.

As a result, it can be noted that even for a small amount of magnetite, relevant pull-off forces can be achieved, such that matching “counter elements” or accessories that are to be held on the sink by means of magnetic force can be detachably positioned there compared to the test example.

The results thus show that the addition of magnetic metal oxides, in particular magnetite, to the curable casting compound, especially as a replacement of the dye(s), results in the provision of a magnetic curable casting compound and thus in a magnetic or magnetizable molded plastic.

The molded plastic components, such as kitchen sinks or the like, manufactured using the curable casting compound according to one embodiment of this invention exhibit magnetic properties that are sufficient to securely and detachably secure matching components by means of magnetic force, compared to the curable casting compound obtained in the comparative example.

The effect of providing magnetic properties thus occurs with the use of magnetic metal oxides, in particular magnetite, according to the invention.

FIG. 2 shows a schematic representation of a securing system according to one embodiment of this invention.

FIG. 2 shows a cross-sectional view of a sink 1 having magnetic properties according to embodiments of the invention. An accessory element in the form of a sink brush 2, which has a permanent magnet 2a in its head, can be attached to a side wall 1a of the sink 1 by means of magnetic force. A further accessory element in the form of a basket 3, for instance for storing a detergent bottle or the like, is made of plastic. By means of a magnetic adhesive strip 3a applied to the back of the basket 3, the basket 3 can then be attached to the side wall 1a of the sink 1.

In summary, at least one of the embodiments of the invention has at least one of the advantages listed below:
improved flexibility in securing additional components on molded plastics.
low application quantity of the required active additive (metal oxide, especially magnetite) and thus low material input costs.
high flexibility with regard to the visual design of surfaces.
simple, inexpensive manufacture.
easy workability.

Although this invention has been described with reference to preferred exemplary embodiments, it is not limited thereto and can be modified in a variety of ways.

### LIST OF REFERENCE NUMERALS

1 sink
1a shell
2 sink brush
2a permanent magnet
3 basket
3a adhesive magnetic strips
10 sink system

1. A curable casting compound for the manufacture of molded plastics comprising a binder component composition and a composition of the filler component, characterized in that the composition of the filler component comprises at least one magnetic metal oxide, in particular magnetite, in a proportion from 1 to 100 percent by weight, in relation to the total mass of the composition of the filler component.

2. The curable casting compound according to claim 1, characterized in that at least one magnetic metal oxide has a proportion of at least 50 percent by weight in relation to the total mass of the composition of the filler component.

3. The curable casting compound according to claim 1, characterized in that the at least one magnetic metal oxide has a proportion of between 15 and 50 per-cent by weight, preferably between 20 and 40 percent by weight, in particular be-tween 25 and 30 percent by weight, in relation to the total mass of the composition of the filler component.

4. The curable casting compound according to claim 1, characterized in that the at least one magnetic metal oxide is provided in the form of granular magnetite.

5. The curable casting compound according to claim 4, characterized in that the granular magnetite has an average diameter between 100 and 500 microns, preferably between 200 and 400 microns, more preferably between 250 and 350 microns.

6. The curable casting compound according to claim 1, characterized in that the binder component composition comprises at least a portion of a liquid monomeric acrylate.

7. The curable casting compound according to claim 1, characterized in that the composition of the filler component comprises a proportion of a peroxide mixture.

8. The curable casting compound according to claim 1, characterized in that the curable casting compound has a colorant material composition of 0.1 percent by weight to 20 percent by weight, in particular of 0.5 percent by weight to 10 percent by weight, in particular of 1 percent by weight to 5 percent by weight.

9. Use of a curable casting compound according to claim 1, for the manufacture of a molded plastic for the kitchen and/or sanitary sector, in particular kitchen sinks and countertops for kitchens.

10. Molded plastic manufactured using the curable molding compound according to claim 1, in particular by means of a casting process.

11. A securing system (10) comprising a molded plastic (1) according to claim 10 and at least one magnetic or magnetizable accessory element (2, 3) for securing to the molded plastic (1) by means of magnetic force.

12. The securing system according to claim 11, characterized in that the accessory element (2, 3) comprises at least one magnetic element (2a, 3a), which is connected to the accessory element, in particular by means of an adhesive connection.
